(19) United States
(12) Patent Application Publication
(10) Pub. No.: US 2015/0356076 A1
(43) Pub. Date: Dec. 10, 2015

(54) SYSTEM AND METHOD OF MACHINE TRANSLATION

(71) Applicant: QATAR FOUNDATION, Doha (QA)

(72) Inventors: Francisco Javier Guzman HERRERA, Doha (QA); Stephan VOGEL, Doha (QA)

(73) Assignee: QATAR FOUNDATION FOR EDUCATION, SCIENCE AND COMMUNITY DEVELOPMENT, Doha (QA)

(21) Appl. No.: 14/760,436

(22) PCT Filed: Jan. 11, 2013
(86) PCT No.: PCT/EP2013/050521

§ 371 Date: Jul. 10, 2015

(51) Int. Cl. G06F 17/28

(52) U.S. Cl. CPC G06F 17/289

(57) ABSTRACT

A machine translation system (1) comprises a language analysis module (3) which receives an unknown text (4) and analyses portions of the unknown text (4). The language analysis module (3) identifies language features in the unknown text (4) and provides the linguistic fingerprint to a translation configuration selection module (5). The translation configuration selection module (5) selects translation configurations (T₁-T₉) from a memory (6) which corresponds with the identified linguistic fingerprints and communicates the selected language configurations (T₁-T₉) to a machine translation module (7). The machine translation module (7) translates the unknown text (4) into a different language using the selected translation configurations (T₁-T₉).

The present invention relates to machine translation systems and methods and more particularly relates to machine translation systems and methods which are operable to translate text written in different styles from a first language to a second language.

A conventional statistical machine translation system uses a translation configuration or translation parameters, which include models for translation and tuning parameters, to translate text from a first language to a second language. The translation models are derived by analysing training data which comprises text passages in both the first and second languages. The tuning parameters are derived by setting the strength (or weight) of each translation model to obtain the best translation according to a given dataset, known as tuning dataset.

A statistical machine translation system can be improved by creating the appropriate translation configuration (retraining the models or the tuning parameters) by using new training data for a specific domain. For instance, a machine translation system can be re-configured using training data comprising text passages written in different writing styles. A machine translation system can therefore be configured to translate text written in different styles, such as text which incorporates legal or slang terms.

The problem with conventional machine translation systems is that it is both difficult and time-consuming to retrain a machine translation system to a specific type of text, because it is necessary to source a lengthy text passage which is written accurately in two different languages.

The present invention seeks to provide improved machine translation systems and methods.

According to embodiments of the present invention, there is provided a machine translation method comprising providing a plurality of translation configurations which each correspond to at least one linguistic fingerprint, receiving a text passage in a first language, identifying at least one linguistic fingerprint in a first portion of text from the text passage, selecting a group of translation configurations from the plurality of translation configurations based on the identified linguistic fingerprint, and translating the first portion of the text passage into a second language using the selected group of translation configurations.

Preferably, the translation configurations are initially grouped into predetermined groups.

Advantageously, each group of translation configurations corresponds to a predetermined text type.

Preferably, a translation configuration is included in more than one of the predetermined groups.

Conveniently, the machine translation method further comprises: identifying at least one linguistic fingerprint in a second portion of text from the text passage, selecting a second group of translation configurations from the plurality of translation configurations which corresponds to each identified linguistic fingerprint in the second portion of text, and translating the second portion of the text passage into the second language using the selected second group of translation configurations.

Advantageously, the method selects the groups of translation configurations dynamically to correspond with each linguistic fingerprint in the text passage.

Conveniently, each portion of text is a single word.

Preferably, each portion of text is a plurality of words.

Advantageously, the method further comprises: generating the translation configurations and storing the translation configurations in a memory.

Another aspect of the present invention provides a machine translation system comprising: a memory storing a plurality of translation configurations which each correspond to at least one linguistic fingerprint, a language analysis module operable to receive a text passage in a first language and to identify at least one linguistic fingerprint in a first portion of text from the text passage, a configuration selection module which is operable to select a group of translation configurations from the plurality of translation configurations which corresponds to each linguistic fingerprint identified by the language analysis module, and a machine translation module operable to translate the first portion of the text passage into a second language using the selected group of translation configurations.

Conveniently, the translation configurations are initially grouped into predetermined groups.

Preferably, each group of translation configurations corresponds to a predetermined text type.

Advantageously, a translation configuration is included in more than one of the predetermined groups.

Conveniently, the language analysis module is operable to identify at least one linguistic fingerprint in a second portion of text from the text passage, the configuration selection module is operable to select a second group of translation configurations from the plurality of translation configurations which corresponds to each identified linguistic fingerprint in the second portion of text and the machine translation module is operable to translate the second portion of the text passage into the second language using the selected second group of translation configurations.

Advantageously, the configuration selection module is operable to select the groups of translation configurations dynamically to correspond with each linguistic fingerprint in the text passage.

Preferably, each portion of text is a single word.

Conveniently, each portion of text is a plurality of words.

Advantageously, the system further comprises: a configuration generator which is operable to generate the translation configurations and store the translation configurations in a memory.

In order that the invention may be more readily understood, and so that further features thereof may be appreciated, embodiments of the invention will now be described, by way of example, with reference to the accompanying drawings in which:

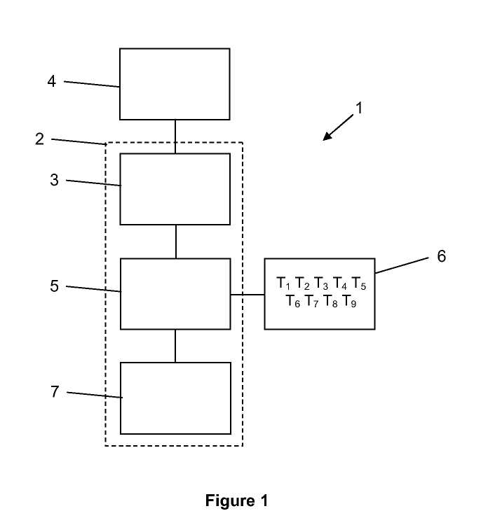

FIG. 1 is a schematic diagram showing a machine translation system of one embodiment of the invention,

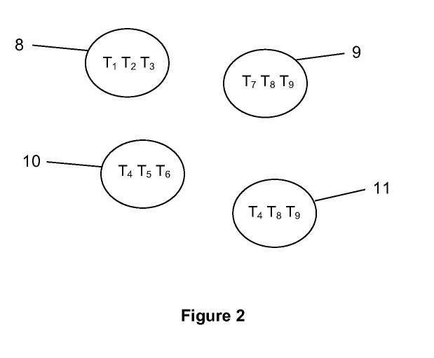

FIG. 2 is a schematic diagram showing four predetermined groups of translation configurations, and

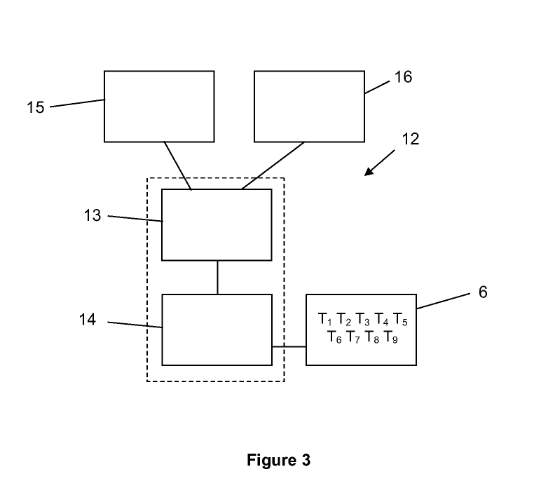

FIG. 3 is a schematic diagram showing a translation configuration generator system which forms one component of an embodiment of the invention.

Referring initially to FIG. 1 of the accompanying drawings, a machine translation system 1 incorporates a processing arrangement 2. The processing arrangement 2 incorporates a language analysis module 3, which is operable to receive an unknown text passage 4. The unknown text passage 4 may comprise a plurality of shorter unknown text passages.

The language analysis module 3 is configured to analyse the language of portions of text from the unknown text 4 and to identify at least one language feature in the text. Each language feature is a feature representing a characteristic of the text, such as, but not limited to, the language type, writing style, linguistic characteristics or complexity. The ensemble of language features and characteristics of a text is hereby referred as a linguistic fingerprint of the text. It is to be appreciated that the language analysis module is configured to identify other possible language features in the unknown text 4 to generate a linguistic fingerprint for such text.

The language analysis module 3 stores each identified language feature as a language fingerprint representing the combined features of the language in the unknown text 4.

The language analysis module 3 is connected to a translation configuration selection module 5. The language analysis module 3 is operable to communicate the identified linguistic fingerprint to the configuration selection module 5.

The translation configuration selection module 5 is in communication with a configuration memory 6 which stores a plurality of predetermined translation configurations T₁-T₉. In other embodiments, the translation configurations T₁-T₉ include different models and tuning parameters. Each of the translation configurations T₁-T₉ are parameters for machine translating particular language characteristics. It is to be appreciated that, whilst only nine translation configurations are shown in FIG. 1, in embodiments of the invention there may be any number of translation configurations. Indeed, in an embodiment of the invention there are an infinite number of configurations, each of which is generated for a uniquely identifying linguistic fingerprint. In one embodiment, the translation configurations are selected statistically to cover any language characteristic, such as short or long sentences, named entities, named brands, verb/noun/adjective positioning in sentences, punctuation etc.

Each translation configuration T₁-T₉ or a group of each translation configuration T₁-T₉ corresponds to one or more linguistic fingerprints. The configuration selection module 5 is operable to search the configuration memory 6 to identify translation configurations T₁-T₉ which correspond to each linguistic fingerprint identified by the language analysis module in the unknown text 4. The configuration selection module 5 is operable to select a group of translation configurations from the plurality of translation configurations T₁-T₉ stored in the configuration memory 6 which corresponds to the linguistic fingerprint identified by the language analysis module 3. The selected group of translation configurations may comprise just one translation configuration or a plurality of translation configurations. The configuration selection module 5 is operable to select a translation configuration for each linguistic fingerprint generated by the language analysis module 3.

Once the translation configuration selection module 5 has selected a group of translation configurations, the configuration selection module 5 communicates the group of translation configurations to a machine translation module 7. The machine translation module 7 uses the selected group of translation configurations in its machine translation algorithm to translate the unknown text 4 into a different language. The machine translation system 1 is therefore operable to analyse an unknown text and select translation configurations dynamically according to the linguistic fingerprint of the text.

In a further embodiment, the language analysis module 3 is operable to analyse a first portion of text from the unknown text 4. The configuration selection module 5 then selects translation configurations corresponding to the linguistic fingerprint of the first portion of text and the machine translation module 7 uses the selected translation configurations to translate the first portion of text, as described above. However, in this further embodiment, the machine translation system 1 is operable to then analyse and translate a second portion of text from the unknown text 4. The second portion of text from the unknown text is analysed separately from the first portion and a different linguistic fingerprint may be identified in the second portion of text as compared with the first portion of text. The translation configurations for the second portion of text are therefore selected independently of the translation configurations for the first portion of text. Consequently, the machine translation system 1 is operable to select translation configurations dynamically for different portions of text in an unknown text.

The machine translation system 1 of this further embodiment is operable to repeat the analysis and machine translation process for all portions of text in the unknown text 4. The machine translation system 1 thus translates the unknown text 4 in portions, with the translation configurations selected dynamically for each portion of text. In embodiments of the invention, each portion may be a single word. Alternatively, at least one portion may be a plurality of words, such as a sentence, paragraph or page.

Referring now to FIG. 2 of the accompanying drawings, in a still further embodiment of the invention, the translation configurations T₁-T₉ are grouped into predetermined groups in the configuration memory 6. In the arrangement shown in FIG. 2, there are four predetermined groups 8-11 but it is to be appreciated that there may be any number of predetermined groups of translation configurations. One translation configuration may be included in more than one group, as indicated by the fourth group 11 shown in FIG. 2.

In one embodiment, the predetermined groups 8-11 are each selected to correspond with a particular text type. The text type may, for instance, be matched to a particular linguistic fingerprint.

In a still further embodiment of the invention, a plurality of predetermined sets of groups of translation configurations are stored in the configuration memory 6. For instance, in the arrangement shown in FIG. 2, a first set comprises the first and second groups 8, 9 and a second set comprises the third to fourth groups 9-11. A set is selected to match a particular text passage type. For instance, a set may be selected for documents using legal terminology. The machine translation system 1 is operable to select groups of translation configurations or sets of groups of translation configurations to correspond with portions of text in the unknown text 4 in order to dynamically optimise the machine translation of the unknown text 4.

The dynamic nature of the selection of the translation configurations enables an embodiment of the invention to optimise the machine translation for all portions of text in an unknown text. An embodiment of the invention is therefore capable of translating individual portions of an unknown text without the system having to be retrained for that text.

Referring now to FIG. 3, a system 12 for generating the translation configurations T₁-T₉ comprises a language analysis module 13 which is connected to a configuration generator 14. The language analysis module 13 is operable to receive portions of parallel text in a first language 15 and a second 16 language. The language analysis modules 13 generates linguistic fingerprints for the input text in the first language 15 and the configuration creation module 14 produces the optimum translation configurations for this input text in the first language 15 and subsequently stores the configurations in the configuration memory 6 for later use by the translation system 1.

When used in this specification and claims, the terms “comprises” and “comprising” and variations thereof mean that the specified features, steps or integers are included. The terms are not to be interpreted to exclude the presence of other features, steps or components.

1. A machine translation method comprising:
providing a plurality of translation configurations which each correspond to at least one linguistic fingerprint,
receiving a text passage in a first language,
identifying at least one linguistic fingerprint in a first portion of text from the text passage,
selecting a group of translation configurations from the plurality of translation configurations based on the identified linguistic fingerprint, and
translating the first portion of the text passage into a second language using the selected group of translation configurations.

2. A machine translation method according to claim 1, wherein the translation configurations are initially grouped into predetermined groups.

3. A machine translation method according to claim 2, wherein each group of translation configurations corresponds to a predetermined text type.

4. A machine translation method according to claim 2, wherein a translation configuration is included in more than one of the predetermined groups.

5. A machine translation method according to claim 2, wherein the method further comprises:
identifying at least one linguistic fingerprint in a second portion of text from the text passage,
selecting a second group of translation configurations from the plurality of translation configurations which corresponds to each identified linguistic fingerprint in the second portion of text, and
translating the second portion of the text passage into the second language using the selected second group of translation configurations

6. A machine translation method according to claim 5, wherein the method selects the groups of translation configurations dynamically to correspond with each linguistic fingerprint in the text passage.

7. A machine translation method according to claim 1, wherein each portion of text is a single word.

8. A machine translation method according to claim 1, wherein each portion of text is a plurality of words.

9. A machine translation method according to claim 1, wherein the method further comprises:
generating the translation configurations and storing the translation configurations in a memory.

10. A machine translation system comprising:
a memory storing a plurality of translation configurations which each correspond to at least one linguistic fingerprint,
a language analysis module operable to receive a text passage in a first language and to identify at least one linguistic fingerprint in a first portion of text from the text passage,
a configuration selection module which is operable to select a group of translation configurations from the plurality of translation configurations which corresponds to each linguistic fingerprint identified by the language analysis module, and
a machine translation module operable to translate the first portion of the text passage into a second language using the selected group of translation configurations.

11. A machine translation system according to claim 10, wherein the translation configurations are initially grouped into predetermined groups.

12. A machine translation system according to claim 11, wherein each group of translation configurations corresponds to a predetermined text type.

13. A machine translation system according to claim 11, wherein a translation configuration is included in more than one of the predetermined groups.

14. A machine translation system according to claim 11, wherein the language analysis module is operable to identify at least one linguistic fingerprint in a second portion of text from the text passage, the configuration selection module is operable to select a second group of translation configurations from the plurality of translation configurations which corresponds to each identified linguistic fingerprint in the second portion of text and the machine translation module is operable to translate the second portion of the text passage into the second language using the selected second group of translation configurations.

15. A machine translation system according to claim 10, wherein the configuration selection module is operable to select the groups of translation configurations dynamically to correspond with each linguistic fingerprint in the text passage.

16. A machine translation system according to claim 10, wherein each portion of text is a single word.

17. A machine translation system according to claim 10, wherein each portion of text is a plurality of words.

18. A machine translation system according to claim 10, wherein the system further comprises:
a configuration generator which is operable to generate the translation configurations and store the translation configurations in a memory.

19. A machine translation method according to claim 1, wherein the translation configurations are initially grouped into predetermined groups; each group of translation configurations corresponds to a predetermined text type; and a translation configuration is included in more than one of the predetermined groups.

20. A machine translation system according to claim 10, wherein the translation configurations are initially grouped into predetermined groups; each group of translation configurations corresponds to a predetermined text type; and a translation configuration is included in more than one of the predetermined groups.
